(19) United States
(12) Patent Application Publication
(10) Pub. No.: US 2015/0097458 A1
(43) Pub. Date: Apr. 9, 2015

(54) Permanent Magnet Electric Machine

(71) Applicant: OTIS ELEVATOR COMPANY, Farmington, CT (US)

(72) Inventors: JimPo Wang, Westford, MA (US); Zbigniew Piech, Cheshire, CT (US)

(73) Assignee: OTIS ELEVATOR COMPANY, Farmington, CT (US)

(21) Appl. No.: 14/394,770

(22) PCT Filed: Apr. 16, 2012
(86) PCT No.: PCT/US2012/033726

§ 371 Date: Oct. 16, 2014

(51) Int. Cl. H02K 1/27

(52) U.S. Cl. CPC H02K 1/2766
USPC 310/156.01

(57) ABSTRACT

A rotor for a permanent magnet electric machine includes a rotor core and a plurality of permanent magnet bundles located at the rotor core. Each permanent magnet bundle includes a first magnet of a first magnetic material and a second magnet of a second magnetic material located radially outboard of the first magnet. The second magnet has an increased resistance to demagnetization relative to the first magnet. A permanent magnet electric machine includes a stator and a rotor magnetically interactive with the stator. The rotor includes a rotor core and a plurality of permanent magnet bundles located at the rotor core. Each permanent magnet bundle includes a first magnet of a first magnetic material and a second magnet of a second magnetic material located radially outboard of the first magnet. The second magnet has an increased resistance to de-magnetization relative to the first magnet.

### BACKGROUND OF THE INVENTION

The subject matter disclosed herein relates to electric machines. More specifically, the subject matter disclosed herein relates to magnetic material for permanent magnet electric machines.

Permanent magnet electric machines have become popular in recent years due to their high efficiency and high power density relative to other types of electric machines. Permanent magnet machines utilize permanent magnets in a machine rotor arranged to form magnetic poles. The permanent magnets in the rotor form a magnetic field that interacts with a stator magnetic field, often formed by electric current passing through a stator winding, to generate torque at the rotor. One key to the popularity of permanent magnet machines has been the utilization of rare earth magnets, such as those of neodymium, neodymium iron boron or samarium-cobalt, as the permanent magnet elements in the machines. Rare earth magnets are typically favored due to their high residual flux density to produce a relatively high flux density in the air gap of electrical machines utilizing rare earth magnets. Typically, flux densities of about 0.65 Tesla are achieved at the air gap between the rotor and stator of such machines. Also, rare earth magnets are highly resistant to demagnetization for their high coercivity, giving the machines a high reliability. The unstable supply of rare earth magnets and their high cost, however, has driven a need for alternative constructions to produce comparable flux density in the air gap and reasonably high demagnetization resistance as machines utilizing rare earth magnets.

### BRIEF DESCRIPTION OF THE INVENTION

According to one aspect of the invention, a rotor for a permanent magnet electric machine includes a rotor core and a plurality of permanent magnet bundles located at the rotor core. Each permanent magnet bundle includes a first magnet of a first magnetic material and a second magnet of a second magnetic material located radially outboard of the first magnet. The second magnet has an increased resistance to demagnetization relative to the first magnet.

Alternatively in this or other aspects of the invention, the first magnet has greater residual flux density but coercivity lower than the second magnet.

Alternatively in this or other aspects of the invention, the first magnet is formed from an alnico alloy.

Alternatively in this or other aspects of the invention, the second magnet is formed from a ferrite material.

Alternatively in this or other aspects of the invention, the first magnet and second magnet are arranged as a permanent magnet bundle.

Alternatively in this or other aspects of the invention, the first magnet and the second magnet of each permanent magnet bundle are located in a common rotor core slot of the rotor core.

Alternatively in this or other aspects of the invention, an additional magnet is located between circumferentially adjacent magnet bundles.

Alternatively in this or other aspects of the invention, the additional magnet is formed from an alnico ally.

Alternatively in this or other aspects of the invention, the additional magnet is located substantially at a pole center of the rotor.

Alternatively in this or other aspects of the invention, the second magnet is a rare earth magnet.

According to another aspect of the invention, a permanent magnet electric machine includes a stator and a rotor magnetically interactive with the stator. The rotor includes a rotor core and a plurality of permanent magnet bundles located at the rotor core. Each permanent magnet bundle includes a first magnet of a first magnetic material and a second magnet of a second magnetic material located radially outboard of the first magnet. The second magnet has an increased resistance to demagnetization relative to the first magnet.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of an embodiment of a permanent magnet electric machine;

FIG. 2 is a cross-sectional view of an embodiment of an electric machine;

FIG. 3 is a cross-sectional view of an embodiment of an electric machine.

The detailed description explains embodiments of the invention, together with advantages and features, by way of example with reference to the drawings.

### DETAILED DESCRIPTION OF THE INVENTION

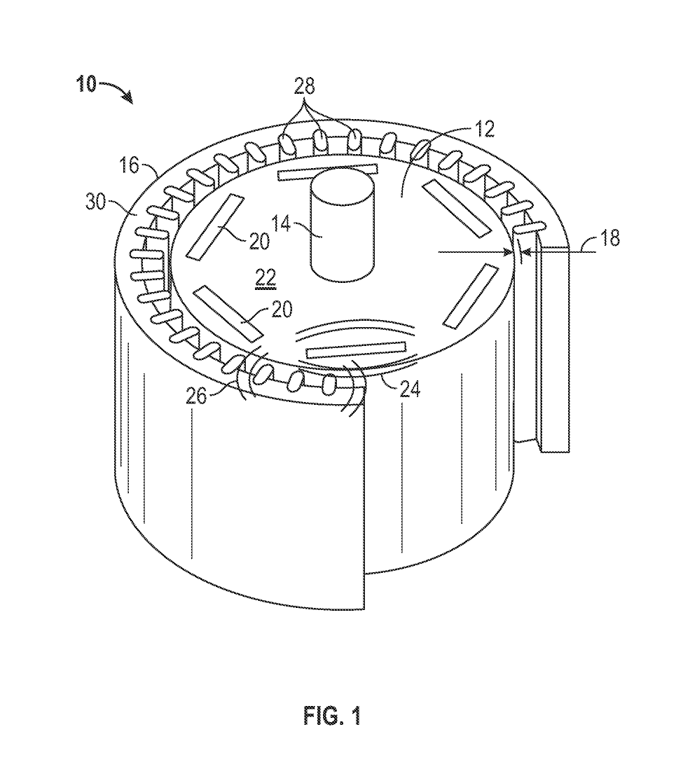

Shown in FIG. 1 is a cross-sectional view of an embodiment of a permanent magnet electric machine 10. The electric machine 10 includes a rotor 12 located about a central shaft 14. A stator 16 is located around the rotor 12, defining an air gap 18 between the rotor 12 and the stator 16. The rotor 12 includes a plurality of permanent magnets 20 secured in a rotor core 22. The permanent magnets 20 are arranged to create a rotor magnetic field 24 that interacts with a stator magnetic field 26. The stator magnetic field 26 is formed by, for example, a flow of electrical current through one or more stator windings 28 located at a stator core 30. The interaction between the stator magnetic field 26 and the rotor magnetic field 24 results in torque applied to the rotor 12, which drives rotation of the shaft 14. Further, the stator current flow results in a demagnetizing field, which can cause demagnetization of the permanent magnets 20, if susceptible to the demagnetization field. The demagnetization field is at its strongest at or near the air gap 18 and progressively weakens as it extends further into the rotor 12 from the air gap 18. The rotation of the shaft 14 may be used to perform work, such as driving one or more ropes or belts of an elevator system(not shown).

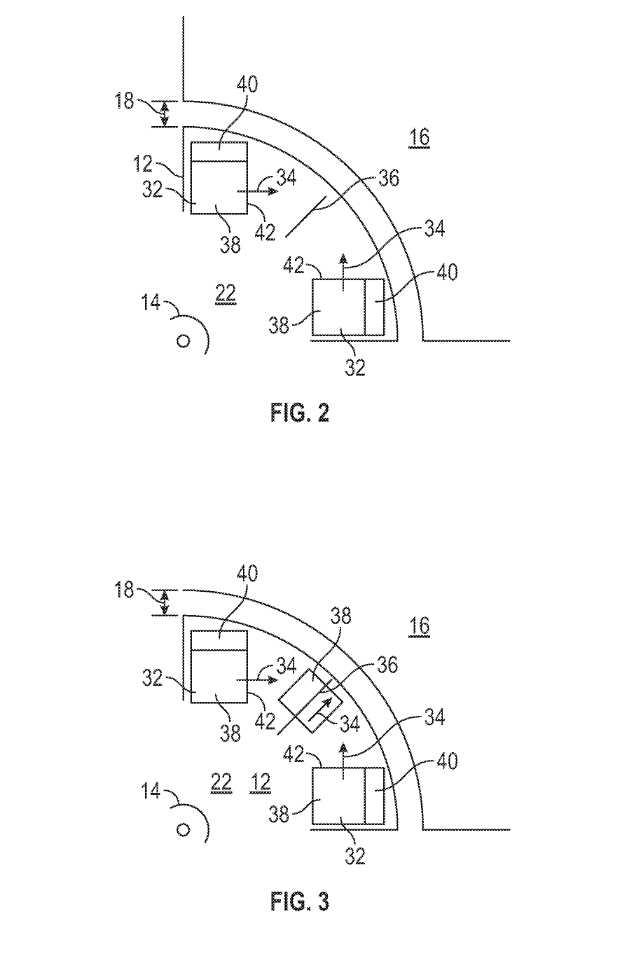

Referring to FIG. 2, a portion of the rotor 12 is shown in an axial cross-sectional view. The rotor 12 may be of any number of poles, including 2, 4, 8, 12 or 16 poles. The permanent magnets 20 of the rotor 12 are arranged as a plurality of permanent magnet bundles 32 secured in the rotor core 22, for example, in rotor core slots 42. The magnet bundles 32 are oriented so that their direction of magnetization 34 is directed toward a pole center 36, and include magnets of two or more materials. A first magnet 38 of the magnet bundle 32 is an alnico alloy, one of a family of iron alloys, which in addition to iron include aluminum (Al), nickel (Ni) and cobalt (Co). The alnico alloy may also include copper (Cu) and/or titanium (Ti). The composition can be 8-12% Al, 15-26% Ni, 5-24% Co, up to 6% Cu, up to 1% Ti, and the balance Fe. As a magnetic material, the alnico alloy is capable of producing a high flux density (also referred to as magnetic induction), or has a high residual flux density, but is susceptible to demagnetization due to its relatively low coercivity. The magnet bundle 32 further includes a second magnet 40 of a ferrite material. Ferrites are ceramic compounds derived from iron oxides such as hematite (Fe₂O₃) or magnetite (Fe₃O₄) as well as oxides of other metals. With their relatively higher coercivity, for example, in a range of about 250 kA/m to about 350 kA/m, ferrite materials are highly resistant to demagnetization relative to alnico alloys, but their residual flux density, in the range of about 0.35 Tesla to about 0.45 Tesla, is lower than an alnico alloy having a residual flux density in the range of about 1.20 Tesla to about 1.35 Tesla, and too low to provide a flux density at the air gap 18 comparable to a rare earth magnet-powered machine.

When used in combination, however, the first magnet 38 of alnico alloy, and the second magnet 40 of a ferrite material in the magnet bundle 32, a flux density and resistance to demagnetization comparable to a rare earth magnet-driven machine is be achieved. As shown in FIG. 2, the first magnet 38 of alnico alloy is secured in the rotor core 22. The second magnet 40 of ferrite is then secured in the rotor core 22 radially outboard of the first magnet 38, closer to the air gap 18 and thus subject to a higher demagnetization field. The second magnet 40, with its higher resistance to demagnetization, protects the first magnet 38 from demagnetization due to its position between the first magnet 38 and the air gap 18 and the stator 16 magnetic field.

Referring now to FIG. 3, in another embodiment an additional first magnet 38 is located between adjacent magnet bundles 32 at the pole center 36. The additional first magnet 38 has a direction of magnetization 34 extending radially outwardly toward the air gap 18. The addition of the additional first magnet 38 to the configuration including magnet bundles 32 of alnico first magnets 38 and ferrite second magnets 40 further increases the flux density in the air gap 18 of the electrical machine 10.

While in the embodiments described above, the magnet bundles 32 comprise alnico first magnets 38 and ferrite second magnets 40, it is to be appreciated that in other embodiments, the second magnets 40 may be of a rare earth material such as neodymium, neodymium iron boron (NdFeB) or samarium-cobalt (SmCo). Sintered NdFeB magnets have a residual flux density up to about 1.5 Tesla, while SmCo magnets have a residual flux density in the range of about 0.9 Tesla to about 1.15 Tesla. The utilization of a small portion, for example, up to about 33%, of rare earth material together with the alnico first magnet 38 reduces the amount of relatively rare and high cost rare earth magnet utilized in the electric machine 10, while still providing a desired flux density.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A rotor for a permanent magnet electric machine comprising:
a rotor core; and
a plurality of permanent magnet bundles disposed at the rotor core, each permanent magnet bundle including:
a first magnet of a first magnetic material; and
a second magnet of a second magnetic material disposed radially outboard of the first magnet, the second magnet having an increased resistance to demagnetization relative to the first magnet.

2. The rotor of claim 1, wherein the first magnet has a residual flux density greater than the second magnet.

3. The rotor of claim 1, wherein the first magnet is formed from an alnico alloy.

4. The rotor of claim 1, wherein the second magnet is formed from a ferrite material.

5. The rotor of claim 1, wherein the first magnet and the second magnet of each permanent magnet bundle are disposed in a common rotor core slot of the rotor core.

6. The rotor of claim 1, further comprising an additional magnet disposed between circumferentially adjacent magnet bundles.

7. The rotor of claim 6, wherein the additional magnet is formed from an alnico alloy.

8. The rotor of claim 6, wherein the additional magnet is disposed substantially at a pole center of the rotor.

9. The rotor of claim 1, wherein the second magnet is a rare earth magnet.

10. A permanent magnet electric machine comprising:
a stator; and
a rotor magnetically interactive with the stator, the rotor including:
a rotor core; and
a plurality of permanent magnet bundles disposed at the rotor core, each permanent magnet bundle including:
a first magnet of a first magnetic material; and
a second magnet of a second magnetic material disposed radially outboard of the first magnet, the second magnet having a increased resistance to demagnetization relative to the first magnet.

11. The electric machine of claim 10, wherein the first magnet has a residual flux density greater than the second magnet.

12. The electric machine of claim 10, wherein the first magnet is formed from an alnico alloy.

13. The electric machine of claim 10, wherein the second magnet is formed from a ferrite material.

14. The electric machine of claim 10, wherein the first magnet and the second magnet of each permanent magnet bundle are disposed in a common rotor core slot of the rotor core.

15. The electric machine of claim 10, further comprising an additional magnet disposed between circumferentially adjacent magnet bundles.

16. The electric machine of claim 15, wherein the additional magnet is formed from an alnico ally.

17. The electric machine of claim 15, wherein the additional magnet is disposed substantially at a pole center of the rotor.

18. The electric machine of claim 10, wherein the second magnet is a rare earth magnet.

19. A rotor for a permanent magnet electric machine comprising:
a rotor core; and
a plurality of permanent magnet bundles disposed at the rotor core, each permanent magnet bundle including:
a first magnet of a first magnetic material; and
a second magnet of a second magnetic material disposed radially outboard of the first magnet;
wherein the permanent magnet bundles:
have a relatively high residual flux density magnet;
have a relatively high coercivity magnet;
include between 0% to about 33% rare earth magnets.
